(19) United States
(12) Patent Application Publication
(10) Pub. No.: US 2010/0291419 A1
(43) Pub. Date: Nov. 18, 2010

(54) BATTERY PACK HEAT EXCHANGER, SYSTEMS, AND METHODS

(75) Inventor: Peng Zhou, El Cerrito, CA (US)

Correspondence Address: HAVERSTOCK & OWENS LLP, 162 N WOLFE ROAD, SUNNYVALE, CA, 94086, US

(73) Assignee: SINOELECTRIC POWERTRAIN CORPORATION, Sunnyvale, CA (US)

(21) Appl. No.: 12/779,893

(22) Filed: May 13, 2010

Related U.S. Application Data
(60) Provisional application No. 61/178,657, filed on May 15, 2009.

(51) Int. Cl. H01M 10/44; H01M 10/50

(52) U.S. Cl. 429/50; 429/120

(57) ABSTRACT

A battery pack heat exchanger, system, and method comprises a plurality of battery modules comprising a heat exchanger having an outer shell and a plurality of cylinders extending within the outer shell. A plurality of battery cells are positioned within the plurality of cylinders and a coolant is poured into the shell via a fill port. As a result, the coolant is able to absorb and dissipate localized heat produced by the battery cells throughout the heat exchanger. Therefore, if one battery cell undergoes a thermal run-away, the heat will be distributed throughout the shell volume thereby greatly reducing the likelihood that battery cells directly adjacent the run-away cell absorb the brunt of the heat and undergo thermal run-away themselves.

### REFERENCE TO RELATED APPLICATIONS

The present application claims priority of U.S. Provisional Pat. App. No. 61/178,657, filed May 15, 2009, which is incorporated herein by reference.

### FIELD OF THE INVENTION

The present invention relates to the field of battery packs for an electric vehicle. More particularly, the present invention relates to a battery pack heat exchanger for dissipating heat generated by a vehicle.

### BACKGROUND

A high energy density rechargeable battery pack is a critical element for increasing the driving ranges of electric vehicles. Among the current common types of rechargeable batteries, lithium ion battery cells have a much higher energy density when compared with lead acid or nickel metal hydride batteries. However, high energy density lithium ion batteries tend to have poor thermal stability. Specifically, lithium ion battery cells with, for example, lithium cobalt oxide or lithium nickel cobalt manganese cathode material undergo thermal run-away at relatively low temperatures. As a result of these thermal run-away events is the battery cell temperature reaches, for example, 600 to 1000 degrees Celsius. Indeed, in many cases, such a thermal run-away can cause the battery cell to explode. Even more damaging however, is the tendency of the thermal energy caused by the thermal run-away in one battery cell to propagate to its neighboring cells and cause the neighboring cells to also undergo thermal run-away. The result of such a chain of events often causes the catastrophic failure of an entire battery pack rather than a malfunctioning cell. Thus, a thermal solution is urgently needed for high density packs.

### SUMMARY OF THE INVENTION

A battery pack heat exchanger, system, and method comprises a plurality of battery modules comprises a heat exchanger having an outer shell and a plurality of cylinders extending within the outer shell. A plurality of battery cells are positioned within the plurality of cylinders and a liquid coolant is present in the shell. Preferably there is one battery cell in each cylinder. The battery cells are mounted within the cylinders to be in thermal contact with the interior wall of the respective cylinder. As a result, the coolant is able to absorb and dissipate localized heat produced by the battery cells throughout the heat exchanger. Therefore, if one battery cell undergoes a thermal run-away, the heat will be distributed throughout the shell volume thereby greatly reducing the likelihood that battery cells directly adjacent the run-away cell absorb the brunt of the heat and undergo thermal run-away as a consequence.

In accordance with a first aspect, the present application relates to a battery module for powering a device. The battery module comprises a heat exchanger having an outer shell and a plurality of separators extending within the outer shell. A first volume is formed within the shell and outside of the separators and a second volume is formed within the separators. A plurality of battery cells are positioned within the plurality of separators. A coolant within the first volume is in contact with an exterior surface of the plurality of separators for dissipating localized heat produced by the battery cells throughout the heat exchanger. In some embodiments, the coolant is a liquid. Alternatively, the coolant is a gas. In some embodiments, the coolant is water, refrigerant, silicon oil, Fluorient or acetone. In some embodiments, the coolant partially fills the first volume such that the coolant is able to both evaporate and maintain contact with each of the separators while that battery module is oriented at any angle. Alternatively, the coolant fully fills the first volume. In some embodiments, the shell further comprises one or more coolant retention elements configured to maintain contact between the coolant and each of the separators while the battery module is rotated through an angle. In some embodiments, the angle is between −30 and +30 degrees. In some embodiments, one or more of the batteries are lithium ion battery cells. Alternatively, one or more of the batteries are lead acid or nickel metal hydride battery cells. In some embodiments, the separators are shaped such that outer surface of the battery cells within the separators is in physical contact with the separators. In some embodiments, the battery cells within the separators are in thermal contact with the separators via a thermal medium such that the battery cells can easily transfer heat to the separators. In some embodiments, the thermal medium is thermal grease, thermal epoxy or a thermal pad. The heat exchanger is formed of one or more of aluminum, copper, stainless steel or thermoplastic. The battery module further comprises a filling port coupled to the shell for filling the shell with the coolant.

In accordance with a second aspect, the present invention relates to a battery pack. The battery pack comprises one or more battery modules for powering a device. Each battery module includes a heat exchanger having an outer shell and a plurality of separators extending within the outer shell. A first volume is formed within the shell and outside of the separators and a second volume is formed within the separators. A plurality of battery cells are positioned within the plurality of separators and a coolant within the first volume and in contact with the plurality of separators for receiving localized heat produced by the battery cells throughout the heat exchanger. One or more coolant manifolds couple the battery modules together and transporting the coolant between the one or more battery modules. In some embodiments, the battery modules are coupled together serially through inlets and or outlets of the batter modules. Alternatively, the battery modules are coupled together in parallel through inlets and or outlets of the batter modules. As still a further alternative, the battery modules are coupled together in a combination of series and parallel connections. The battery pack further comprises a coolant circulating mechanism coupled with the one or more battery modules through the one or more coolant manifolds. In some embodiments, the coolant circulating mechanism is a pump. The battery pack further comprises a secondary heat exchanger coupled with the one or more battery modules via the one or more coolant manifolds for rejecting heat from the coolant. In some embodiments, the secondary heat exchanger is a radiator or a coolant-refrigerant heat exchanger. In some embodiments, the coolant is a liquid. Alternatively, the coolant is a gas. In some embodiments, the coolant is water, refrigerant, silicon oil, Fluorient™ or acetone. In some embodiments, the coolant only partially fills the first volume. Alternatively, the coolant fully fills the first volume. In some embodiments, each shell further comprises one or more coolant retention elements configured to maintain contact between the coolant and each of the separators while the battery pack is on an angle. In some embodiments, the angle is between −30 and +30 degrees. In some embodiments, one or more of the batteries are lithium ion battery cells. Alternatively, one or more of the batteries are lead acid or nickel metal hydride battery cells. In some embodiments, the separators are shaped such that outer surface of the battery cells within the separators is in physical contact with the separators. In some embodiments, the battery cells within the separators are in thermal contact with the separators via a thermal medium such that the battery cells are able to easily transfer heat to the separators. In some embodiments, the thermal medium is thermal grease, thermal epoxy or a thermal pad. In some embodiments, each heat exchanger is composed of one or more of aluminum, copper, stainless steel or thermoplastic. The battery pack further comprises a filling port coupled to the shell for filling the first volume with the coolant. In some embodiments, the device is an electric vehicle.

In accordance with a third aspect, the present application relates to a system for powering an electric device. The system comprises one or more battery packs comprising one or more battery modules for powering the device. Each battery module comprises a heat exchanger having an outer shell and a plurality of separators extending within the outer shell. A first volume is foamed within the shell and outside of the separators and a second volume is formed within the separators. A plurality of battery cells are positioned within the plurality of separators. A coolant is provided within the first volume in contact with the plurality of separators for removing localized heat produced by the battery cells throughout the heat exchanger. One or more coolant manifolds are provided for coupling the battery modules together and for transporting the coolant between the one or more battery modules. In some embodiments, the battery modules are electrically coupled together serially. Alternatively, the battery modules are electrically coupled together in parallel. The system further comprises a coolant circulating mechanism coupled with the one or more battery modules through the one or more coolant manifolds. In some embodiments, the coolant circulating mechanism is a pump. The system further comprises a secondary heat exchanger coupled with the one or more battery modules via the one or more coolant manifolds for rejecting heat from the coolant. In some embodiments, the secondary heat exchanger is a radiator or a coolant-refrigerant heat exchanger. In some embodiments, the secondary heat exchanger and coolant circulating mechanism are integral to the battery packs. Alternatively, the secondary heat exchanger and coolant circulating mechanism are integral to the electric device. In some embodiments, the coolant is a liquid. Alternatively, the coolant is a gas. In some embodiments, the coolant is water, refrigerant, silicon oil, Fluorient™ or acetone. In some embodiments, the coolant partially fills the first volume such that the coolant is able to both evaporate and maintain contact with each of the separators while that battery pack is oriented at many angles. Alternatively, the coolant fully fills the first volume. In some embodiments, each shell further comprises one or more coolant retention elements configured to maintain contact between the coolant and each of the separators while the battery pack is rotated through many angles. In some embodiments, the range of angles is between −30 and +30 degrees. In some embodiments, one or more of the batteries are lithium ion battery cells. Alternatively, one or more of the batteries are lead acid or nickel metal hydride battery cells. In some embodiments, the separators are shaped such that an outer surface of the battery cells within the separators is in physical contact with the separators. Alternatively, the battery cells within the separators are in thermal contact with the separators via a thermal medium such that the battery cells are able to easily transfer heat to the separators. In some embodiments, the thermal medium is thermal grease, thermal epoxy or a thermal pad. In some embodiments, each heat exchanger is composed of one or more of aluminum, copper, stainless steel or thermoplastic. The system further comprises a filling port coupled to the shell for filling the first volume with the coolant. In some embodiments, the device is an electric vehicle.

In accordance with a fourth aspect, the present application relates to a method of operating a battery pack. The method comprises positioning a plurality of battery cells within a plurality of separators extending within shells of heat exchangers of one or more battery modules. A first volume is formed within the shell and outside of the separators and a second volume is formed within the separators. The coolant is circulated throughout the first volume of the battery modules via one or more coolant manifolds coupling the battery modules together. The coolant circulating throughout the first volume contacts with the plurality of separators for removing localized heat produced by the battery cells throughout the heat exchanger. The method further comprises flowing the coolant to a secondary heat exchanger via the one or more coolant manifolds in order to dissipate heat received by the coolant from the battery cells. In some embodiments, the secondary heat exchanger is integral to the battery pack. Alternatively, the secondary heat exchanger is integral to an electric vehicle. The method further comprises docking the battery pack with a docking station of the electric vehicle such that the one or more coolant manifolds are coupled with the secondary heat exchanger.

Other features of the present invention will become apparent from consideration of the following description taken in conjunction with the accompanying drawings.

### BRIEF DESCRIPTION OF THE DRAWINGS

The novel features of the invention are set forth in the appended claims. However, for purposes of explanation, several embodiments of the invention are set forth in the following figures.

FIG. 1A illustrates a top view of a battery module in accordance with some embodiments of the present application.

FIG. 1B illustrates a side/cross-sectional view of a battery module in accordance with some embodiments of the present application.

FIG. 1C illustrates a side/cross-sectional view of a battery module with coolant retention elements in accordance with some embodiments of the present application.

FIG. 1D illustrates a side/cross-sectional view of a battery module with coolant retention elements tilted at an angle in accordance with some embodiments of the present application.

FIG. 2 illustrates a battery pack in accordance with some embodiments of the present application.

FIG. 3 illustrates a process flow diagram for a method of operating a battery pack heat exchanger in accordance with some embodiments of the present application.

### DETAILED DESCRIPTION

In the following description, numerous details and alternatives are set forth for the purpose of explanation. However, one of ordinary skill in the art will realize that the invention can be practiced without the use of these specific details. In other instances, well-known structures and devices are shown in block diagram form in order not to obscure the description of the invention with unnecessary detail.

The battery pack heat exchanger, system and method described herein is designed to effectively dissipate heat created by thermal run-away of rechargeable battery cells. Specifically, the battery pack heat exchanger is able to transfer heat from the battery cells to a coolant, wherein the coolant distributes the absorbed heat throughout the battery pack. As a result, if one battery cell undergoes a thermal run-away, the heat will be distributed throughout the shell volume thereby greatly reducing the likelihood that battery cells directly adjacent the run-away cell absorb the brunt of the heat and undergo thermal run-away themselves. This heat distribution is able to be achieved passively by the coolants placement within the heat exchanger, or actively through circulation of the coolant through the heat exchanger in order to actively dissipate heat produced by the battery cells. As a result, the battery pack comprising one or more battery modules is able to be safely utilized to power electrical vehicles and other electrical devices including electric cars and busses.

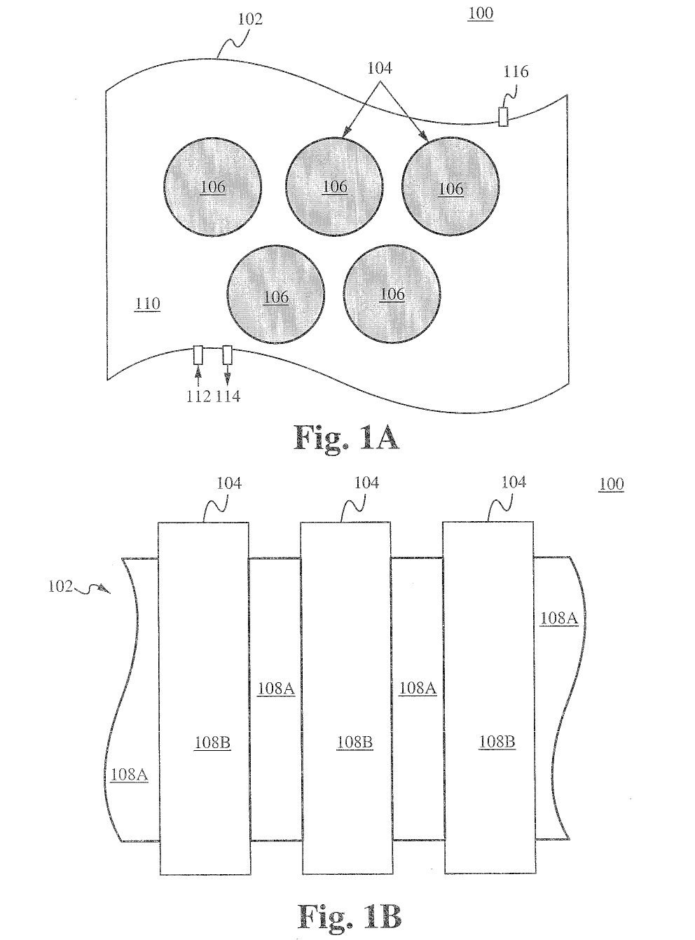

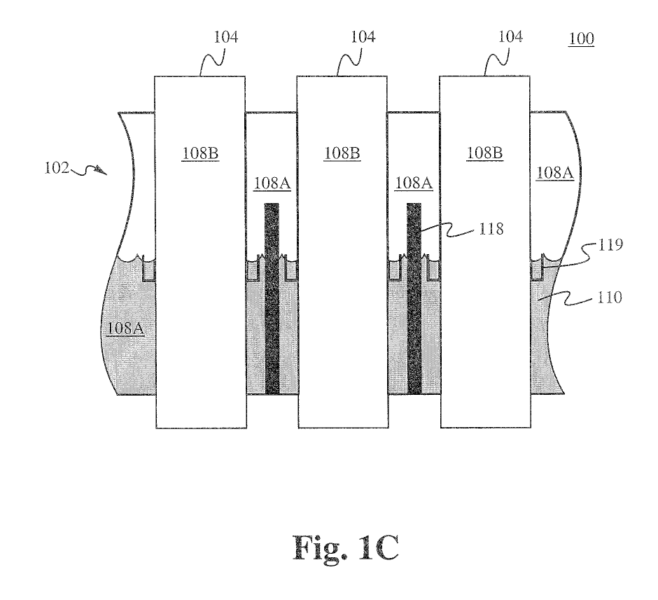

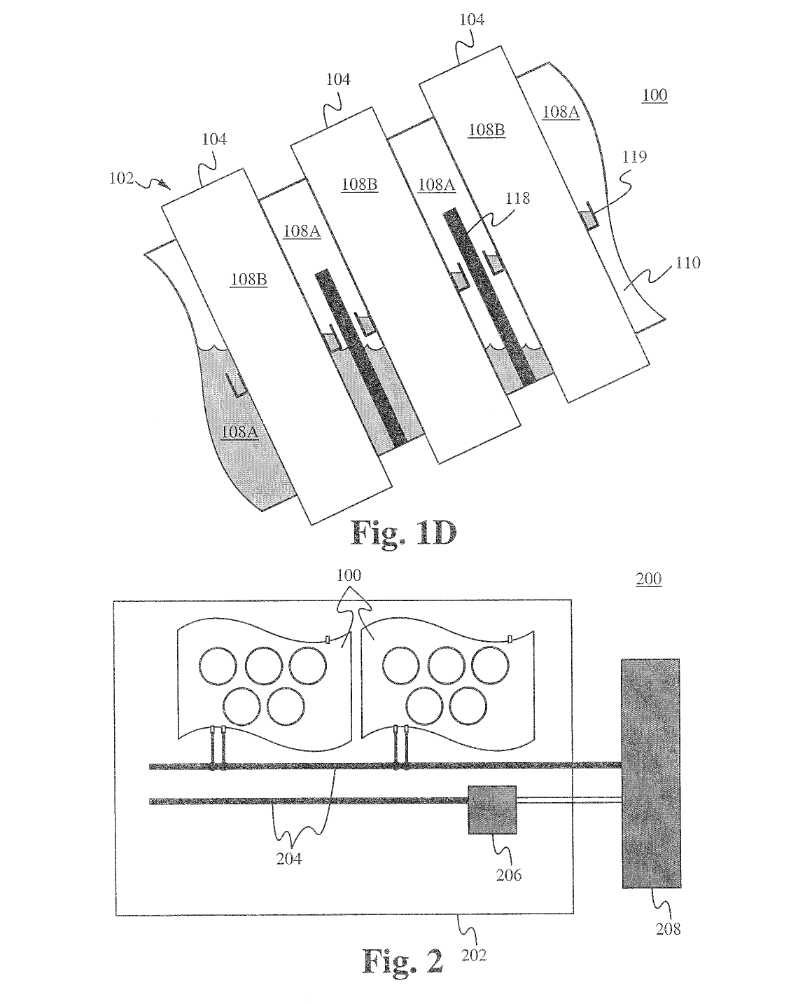

FIGS. 1A and 1B illustrate a top view and side/cross-sectional view of a battery module according to some embodiments. The battery module 100 of FIGS. 1A and 1B comprise a heat exchanger having an outer shell 102 and one or more separators 104, one or more battery cells 106 and coolant 110. In some embodiments, the heat exchanger is able to comprise less or additional separators 104 as long as each of the separators are able to fit within the shell 102. The one or more separators 104 are preferably positioned in a honeycomb formation. Alternatively, other formations are conceived as are well known in the art.

The heat exchanger is formed of aluminum, copper, stainless steel, thermoplastic or a combination thereof. Alternatively, the heat exchanger is able to be made of a suitable heat transferring material or combination of suitable heat transferring materials as are well known in the art. The heat exchanger defines a first volume 108A between the inner surface of the shell 102 and the outer surface of the separators 104, and a second volume 108B within the separators 104. The method of fabricating the heat exchanger can be formed by is able to be brazing, soldering, molding, casting, mechanical interference assembly or a combination thereof between the separators 104 and the shell 102. In some embodiments, the heat exchanger further comprises a fill port 116 for filling the first volume 180A of the heat exchanger with coolant 110, and an inlet 112 and an outlet 114 for transporting the coolant 110 in and out of the first volume 180A. Alternatively, the heat exchanger 101 only comprises a fill port 116 and the coolant 110 remains in the same shell 102 throughout operation. Alternatively, the heat exchanger comprises a number of fill ports 116 and inlet 112 and outlets 114.

The shell 102 portion of the heat exchanger is able to have a rectangular solid shape. Alternatively, the shell 102 is able to comprise a shape capable of surrounding at least a portion of the separators 104. The separators 104 of the heat exchanger 101 are able to be cylindrical in shape having a diameter of approximately 18 millimeters and a height of approximately 65 millimeters. Alternatively, the separators 104 are able to have any height and/or diameter, and be cylindrical or a shape capable of housing one or more battery cells 106. In some embodiments, the separators 104 are shaped such that when one or more battery cells 106 are positioned within the second volume 108B within the separators 104, all or most of the outer surface of the battery cells is in physical contact with the inner surface of the separators 104. In some embodiments, the spacing between the separators 104 is approximately 5 millimeters. Alternatively, other spacing configurations are able to be used depending on the properties of the coolant 110, battery cells 106, heat exchanger 101 and desired safety standards. The separators 104 are able to extend through the body of the shell 102. Alternatively, the separators 104 are able to extend only partially into the shell 102.

The one or more battery cells 106 are able to be lithium ion battery cells. In some embodiments, the battery cells 106 are able to be lead acid, nickel metal hydride or other type of rechargeable battery or combination thereof. Alternatively, the battery cells 106 are able to be other rechargeable storage means as are well known in the art. The battery cells 106 are positioned within the second volume 180B within the plurality of separators 104. In some embodiments, each separator 104 contains one battery cell 106. Alternatively, one or more of the separators 104 contain more than one battery cell 106. In some embodiments, the battery cells 106 and the separators 104 are configured such that when one or more battery cells 106 are within the separators 104, substantially all of the surface of the battery cells 106 is in physical contact with the separators 104. As a result, the battery cells 106 are able to directly transfer heat to the separators 104, which transfer said heat to the coolant 110 within the first volume 108A. Alternatively, some or all of the surface of the battery cells 106 is able to not be in physical contact with the separators 104. In some embodiments, the battery cells 106 are preferably in thermal contact with the separators 104 through a thermal medium (not shown). Specifically, the thermal medium is able to be used within the second volume 108B as a buffer between the battery cells 106 and the separators 104 such that the thermal medium increases the ability of heat from the battery cells 106 to be transferred to the separators 104. The thermal medium is able to comprise thermal grease, thermal epoxy, a thermal pad or a combination thereof. Alternatively, the thermal medium is able to be a medium with properties such that the thermal medium is able to efficiently absorb and transfer heat. Any combination of thermal, physical and no contact between the battery cells 106 and the separators 104 is contemplated.

The coolant 110 is able to comprise air, water, refrigerant, silicon oil, acetone, Fluorient™ or a combination thereof. Alternatively, the coolant 110 is able to comprise liquids, gases or combinations thereof capable of efficiently absorbing and dissipating localized heat as are well known in the art. The coolant 110 is able to fill the first volume 108A such that at any orientation of the battery module 100, the coolant 110 is able to still be in contact with the surface of the separators 104. Alternatively, the coolant 110 only partially fills the first volume 108A. In operation, when in contact with the separators 104, the coolant 110 functions to absorb heat from the battery cells 106 via the separators 104 and/or the thermal medium. Upon absorption, the coolant 110 dissipates the heat received from the battery cells 106 throughout the heat exchanger such that the heat is not localized near any one battery cell 106. Further, as the temperature of the coolant 110 reaches boiling point, the latent heat of the coolant 110 keeps the temperature from rising while the coolant 110 goes through a phase transition. As a result, the temperature of the coolant 110 is essentially “capped” until the phase transition is complete thereby further protecting against thermal run-away. Accordingly, the battery module 100 is able to safely distribute heat produced by the battery cells 106 and thereby reduce the risk of battery cell thermal run-away. Additionally, the battery module 100 is able to prevent the thermal run-away of one battery cell 106 from causing thermal run-away in adjacent battery cells 106 due to a localized temperature rise around the battery cell experiencing a thermal run-away.

FIG. 1C illustrates side/cross-sectional view of an alternative embodiment of a battery module 100. The battery module 100 is substantially similar to the battery module 100 shown in FIGS. 1A and 1B except for the differences described herein. Specifically, within the embodiment shown in FIG. 1C, the coolant 110 is able to be an evaporative liquid that only partially fills the first volume 108A and the heat exchanger 101 comprises one or more coolant retaining elements 118, and one or more coolant retention scoops 119. The coolant retention scoops 119 are coupled to the separators 104. Also, it should be noted that although the coolant retention scoops 119 are substantially rectangular as shown in FIGS. 1C and 1D, the scoops 119 are able to comprise any concave shape capable of keeping the coolant 110 in contact with the separators 104. In some embodiments, the coolant 110 has a boiling point between 40° and 130° Celsius. It is understood that any number of coolant retaining elements 118 and/or coolant retention scoops 119 are able to be included within the heat exchanger 101. In some embodiments, each separator 104 has a corresponding coolant retaining element 118. In some embodiments, each separator 104 has one or more corresponding coolant retention scoops 119 coupled to the corresponding separator 104. The coolant retaining elements 118 and/or coolant retention scoops 119 are able to comprise aluminum, copper stainless steel, thermoplastic or a combination thereof. Alternatively, the coolant retaining elements 118 and/or coolant retention scoops 119 are able to be made of a suitable heat transferring material or combination of suitable heat transferring materials as are well known in the art.

The coolant retaining elements 118 and coolant retention scoops 119 are configured such that when a battery module 100 is on an angle, each of the separators 104 and corresponding battery cells 106 remain in substantial contact with the coolant 110. In particular, as shown in FIG. 1D, the coolant retaining elements 118 and/or coolant retention scoops 119 are able to be positioned such that as the battery module 100 is tilted, each portion of the coolant 110 adjacent to each coolant retaining element 118 is still able to build up on the nearest coolant retaining element 118 and/or coolant retention scoop 119, instead of flowing elsewhere or drying up. In some embodiments, the angle at which the battery module 100 is able to be tilted wherein the coolant retaining elements 118 and/or coolant retention scoops 119 are still able to keep the coolant 110 in contact with the separators 104 is between −30 and +30 degrees. In another embodiment, the angle is able to be any angle. In an alternative embodiment, the first volume 108A is again only partially filled by the coolant 110, but the heat exchanger 101 does not include coolant retaining elements 118 or coolant retention scoops 119. In such an embodiment, the amount of coolant 110 included within the first volume 108A is configured such that regardless of whether the battery module 100 is on an angle, a sufficient amount of coolant 110 will always be in contact with the separators 104. For example, the amount of coolant 110 is such that even if the battery module 100 is tipped onto its side or upside down, the coolant will still be in contact with each of the separators 104.

In operation, similar to as described above in FIGS. 1A and 1B, when in contact with the separators 104, the coolant 110 functions to absorb heat from the battery cells 106 through the separators 104 and/or the thermal medium. However, upon absorption, not only does the heat from the battery cells 106 dissipate throughout the liquid coolant 110, the heat also causes the coolant 110 to vaporize/evaporate wherein the vapor carries the heat via latent heat throughout the heat exchanger 101 and condenses remotely. Thus, due to the partial filling of the first volume 108A by the coolant 110, the heat exchanger 101 becomes a gravity fed two-phase thermal siphon such that the vapor phase of the coolant 110 distributes local heat absorbed by the liquid phase. In addition, this two-phase thermal siphon embodiment enables automatic circulation of the coolant 110 due to the continuous redistribution of the coolant 110 that is enabled by the continuous localized evaporation and remote condensation of the coolant 110 within the unfilled portion of volume 108A. Moreover, this embodiment retains the boiling point temperature “capping” due to the transition phase/latent heat of the coolant 110 as described above in reference to FIGS. 1A and 1B. Accordingly, the battery module 100 is able to safely distribute heat produced by the battery cells 106 and thereby reduce the risk of battery cell thermal run-away in the principal battery cell and its adjacent battery cells.

FIG. 2 illustrates a battery pack 200 according to some embodiments. The battery pack 200 comprises a housing 202, one or more battery modules 100 and one or more manifolds 204. In some embodiments, the battery pack 200 further comprises one or more circulating mechanisms 206 and/or one or more secondary heat exchangers 208. The battery modules 100 are stored within the housing 202 and are able to be coupled with each other through the one or more manifolds 204 via the inlets 112 and/or outlets 114. In some embodiments, the battery modules 100 are coupled with each other in series through the inlets 112 and outlets 114 of the battery modules 100. In some embodiments, the battery modules 100 are able to be coupled with each other in parallel through the inlets 112 and outlets 114 of the battery modules 100. In some embodiments, the battery modules 100 are further able to be coupled with the one or more circulating mechanisms 206 and/or the one or more secondary heat exchangers 208 through the one or more manifolds 204. In some embodiments, the one or more circulating mechanisms 206 and/or one or more secondary heat exchangers 208 are able to be enclosed by the housing 202 such that one or both are integral to the battery pack 200. Alternatively, one or both of the circulating mechanisms 206 and secondary heat exchangers 208 are able to be external to the housing 202 and therefore external to the battery pack 200. In some embodiments, if external to the battery pack 200, the circulating mechanisms 206 and/or secondary heat exchangers 208 are integral to an electronic device (not shown) powered by the battery pack 200. In some embodiments, the electronic device is an electric vehicle.

The one or more circulating mechanisms 206 comprises a pump. Alternatively, the circulating mechanisms 206 comprise a fan, other circulating device or combination thereof as are well known in the art. The one or more secondary heat exchangers 208 are able to comprise a radiator. Alternatively, the one or more secondary heat exchangers 208 are able to comprise a coolant-refrigerant heat exchanger, other heat exchanging devices or combinations thereof as are well known in the art. In some embodiments, the secondary heat exchanger 208 is able to be the radiator of the electrical vehicle powered by the battery pack 200. Alternatively, the secondary heat exchanger 208 is able to be other heat exchanging mechanisms integral to the electronic device powered by the battery pack 200.

The one or more manifolds 204 comprise aluminum, copper stainless steel, thermoplastic or a combination thereof. Alternatively, the one or more manifolds 204 made of other suitable coolant transferring material or combination of suitable coolant transferring materials as are well known in the art. In some embodiments, if the circulating mechanism 206 and/or secondary heat exchanger 208 are external to the battery pack 200, the one or more of the manifolds 204 are configured to dock with inlets and/or outlets (not shown) of the circulating mechanism 206 and/or secondary heat exchanger 208. As a result, of the docking the one or more manifolds 204 are coupled with the circulating mechanism 206 and/or secondary heat exchanger 208 and are able to have the coolant 110 pumped by the circulating mechanism 206 through out the battery modules 100 as well as to the secondary heat exchanger 208. When not docked, the portion of the manifolds 204 configured to dock are also configured to be closed such that coolant 110 is not able to leak out of the battery pack 200.

In operation, the one or more circulating mechanisms 206 are able to circulate the coolant 110 throughout the battery modules 100 such that localized heat produced by the battery cells 106 is further dissipated. In some embodiments, the circulating mechanisms 206 are able to also circulate the coolant 110 through the secondary heat exchangers 208 such that heat received by the coolant 110 from the battery cells 106 is absorbed by the secondary heat exchangers 208 and thus, this cooler coolant 110 is able to return to the battery modules 100 in order dissipate more heat. It is understood that this circulating mechanism 206 and/or secondary heat exchanger 208 circulating process is able to work in concert with the full volume 108A dissipation process and/or the partially full volume 108A two-phase thermal siphon process described above.

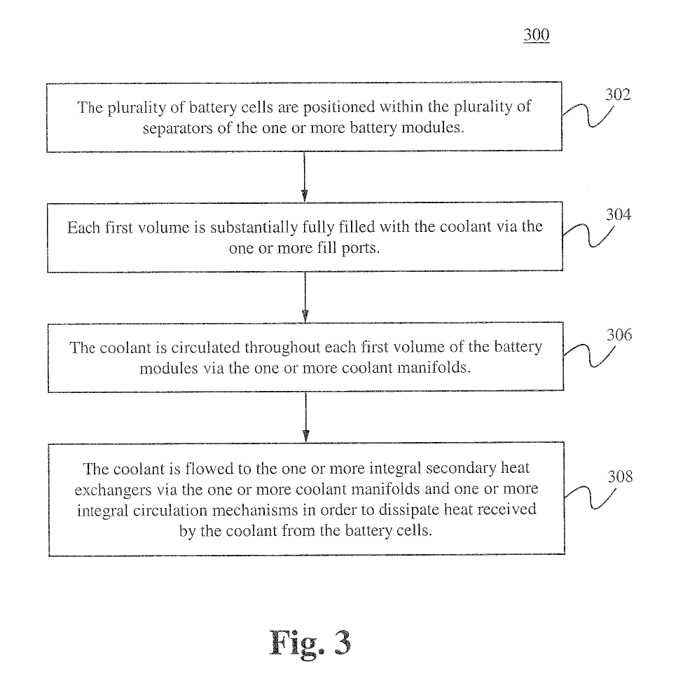

The operation of the battery pack 200 will now be discussed in conjunction with a flow chart 300 illustrated in FIG. 3 and described relative to FIGS. 1A-1C and 2. At the step 302, the plurality of battery cells 106 are positioned within the plurality of separators 104 of the one or more battery modules 100. At the step 304, each first volume 108A is substantially fully filled with the coolant 110 via the one or more fill ports 116. Alternatively, each first volume 108A is only partially filled with the coolant 110 via the one or more fill ports 116. At the step 306, the coolant 110 is circulated throughout each first volume 108A of the battery modules 100 via the one or more coolant manifolds 204. At the step 308, the coolant 110 is flowed to the one or more integral secondary heat exchangers 208 via the one or more coolant manifolds 204 and one or more integral circulation mechanisms 206 in order to dissipate heat received by the coolant 110 from the battery cells 106. Alternatively, the one or more manifolds 204 are docked with the inlets and/or outlets of the external circulating mechanism 206 and/or external secondary heat exchanger 208 such that the coolant 110 is flowed to the external one or more secondary heat exchangers 208 in order to dissipate heat received by the coolant 110 from the battery cells 106.

The battery pack heat exchanger, system and method described herein has numerous advantages. Specifically, the battery pack heat exchanger is able to effectively dissipate localized heat produced by battery cells such that the battery cells are less likely to experience thermal run-away. Thus, by dissipating localized heat, the battery pack exchanger has the advantage of decreasing the likelihood of the thermal run-away of one battery cell causing the run-away of its adjacent battery cells due to an increased localized temperature. Further, the battery pack heat exchanger has the advantage of being able to dock with existing heat exchangers integral to the electric device the battery pack is powering, thereby enabling the use of the external heat exchanger to further protect against thermal run-away. Moreover, the battery pack heat exchanger has the advantage of a coolant “capped” temperature because it utilizes the boiling point of a coolant to “cap” the temperature of the coolant as it dissipates the heat from the battery cells. Even further, the battery pack heat exchanger provides the additional advantage of a automatically re-circulating coolant through a two-phase thermal siphoning process. Accordingly, the battery pack heat exchanger, system and method described herein is able to provide a high density battery pack that is safe from the threat of thermal run-away and associated battery cell explosions.

The battery pack heat exchanger, system and method has been described in terms of specific embodiments incorporating details to facilitate the understanding of the principles of construction and operation of the cascade power system. The specific configurations shown and the methodologies described in relation to the various modules and the interconnections therebetween are for exemplary purposes only. Such reference herein to specific embodiments and details thereof is not intended to limit the scope of the claims appended hereto. It will be apparent to those skilled in the art that modifications may be made in the embodiments chosen for illustration without departing from the spirit and scope of the battery pack heat exchanger, system and method.

What is claimed is:

1. A battery module for powering a device comprising:
a. a heat exchanger having an outer shell and a plurality of separators extending within the outer shell, wherein a first volume is formed within the shell and outside of the separators and a second volume is formed within the separators;
b. a plurality of battery cells positioned within the plurality of separators; and
c. a coolant within the first volume in contact with the plurality of separators for dissipating localized heat produced by the battery cells throughout the heat exchanger.

2. The battery module of claim 1, wherein the coolant is a gas.

3. The battery module of claim 1, wherein the coolant is a liquid.

4. The battery module of claim 3, wherein the coolant is water, refrigerant, silicon oil, Fluorient™ or acetone.

5. The battery module of claim 3, wherein the coolant partially fills the first volume such that the coolant is able to both evaporate and maintain contact with each of the separators while that battery module is oriented at any angle.

6. The battery module of claim 3, wherein the coolant fully fills the first volume.

7. The battery module of claim 3, wherein the shell further comprises one or more coolant retention elements configured to maintain contact between the coolant and each of the separators while the battery module is on an angle.

8. The battery module of claim 1, wherein one or more of the batteries are lithium ion battery cells.

9. The battery module of claim 1, wherein the separators are shaped such that outer surface of the battery cells within the separators is in physical contact with the separators.

10. The battery module of claim 1, wherein the battery cells within the separators are in thermal contact with the separators via a thermal medium such that the battery cells are able to easily transfer heat to the separators.

11. The battery module of claim 10, wherein the thermal medium is thermal grease, thermal epoxy or a thermal pad.

12. The battery module of claim 1 wherein the heat exchanger is composed of one or more of aluminum, copper, stainless steel or thermoplastic.

13. The battery module of claim 1, further comprising a filling port coupled to the shell for filling the shell with the coolant.

14. A battery pack comprising:
a. one or more battery modules for powering a device, each battery module comprising:
i. a heat exchanger having an outer shell and a plurality of separators extending within the outer shell, wherein a first volume is formed within the shell and outside of the separators and a second volume is formed within the separators;
ii. a plurality of battery cells positioned within the plurality of separators; and
iii. a coolant within the first volume in contact with the plurality of separators for dissipating localized heat produced by the battery cells throughout the heat exchanger;
b. one or more coolant manifolds for coupling the battery modules together and transporting the coolant between the one or more battery modules.

15. The battery pack of claim 14, wherein the battery modules are coupled together serially through inlets and or outlets of the battery modules.

16. The battery pack of claim 14, wherein the battery modules are coupled together in parallel through inlets and or outlets of the batter modules.

17. The battery pack of claim 14, further comprising a coolant circulating mechanism coupled with the one or more battery modules through the one or more coolant manifolds.

18. The battery pack of claim 17, wherein the coolant circulating mechanism is a pump.

19. The battery pack of claim 17, further comprising a secondary heat exchanger coupled with the one or more battery modules via the one or more coolant manifolds for absorbing heat from the coolant.

20. The battery pack of claim 19, wherein the secondary heat exchanger is a radiator or a coolant-refrigerant heat exchanger.

21. The battery pack of claim 14, wherein the coolant is a gas.

22. The battery pack of claim 14, wherein the coolant is a liquid.

23. The battery pack of claim 22, wherein the coolant is water, refrigerant, silicon oil, Fluorient™ or acetone.

24. The battery pack of claim 22, wherein the coolant only partially fills the first volume.

25. The battery pack of claim 22, wherein the coolant fully fills the first volume.

26. The battery pack of claim 22, wherein each shell further comprises one or more coolant retention elements configured to maintain contact between the coolant and each of the separators while the battery pack is on an angle.

27. The battery pack of claim 14, wherein one or more of the batteries are lithium ion battery cells.

28. The battery pack of claim 14, wherein the separators are shaped such that outer surface of the battery cells within the separators is in physical contact with the separators.

29. The battery pack of claim 14, wherein the battery cells within the separators are in thermal contact with the separators via a thermal medium such that the battery cells are able to easily transfer heat to the separators.

30. The battery pack of claim 29, wherein the thermal medium is thermal grease, thermal epoxy or a thermal pad.

31. The battery pack of claim 14, wherein each heat exchanger is composed of one or more of aluminum, copper, stainless steel or thermoplastic.

32. The battery pack of claim 14, further comprising a filling port coupled to the shell for filling the first volume with the coolant.

33. The battery pack of claim 14, wherein the device is an electric vehicle.

34. A system for powering an electric device comprising:
a. one or more battery packs comprising one or more battery modules for powering the device, each battery module comprising:
i. a heat exchanger having an outer shell and a plurality of separators extending within the outer shell, wherein a first volume is formed within the shell and outside of the separators and a second volume is formed within the separators;
ii. a plurality of battery cells positioned within the plurality of separators; and
iii. a coolant within the first volume in contact with the plurality of separators for dissipating localized heat produced by the battery cells throughout the heat exchanger;
b. one or more coolant manifolds for coupling the battery modules together and transporting the coolant between the one or more battery modules.

35. The system of claim 34, wherein the battery modules are coupled together serially through inlets and or outlets of the batter modules.

36. The system of claim 34, wherein the battery modules are coupled together in parallel through inlets and or outlets of the batter modules.

37. The system of claim 34, further comprising a coolant circulating mechanism coupled with the one or more battery modules through the one or more coolant manifolds.

38. The system of claim 37, wherein the coolant circulating mechanism is a pump.

39. The system of claim 37, further comprising a secondary heat exchanger coupled with the one or more battery modules via the one or more coolant manifolds for absorbing heat from the coolant.

40. The system of claim 39, wherein the secondary heat exchanger is a radiator or a coolant-refrigerant heat exchanger.

41. The system of claim 39, wherein the secondary heat exchanger and coolant circulating mechanism are integral to the battery packs.

42. The system of claim 39, wherein the secondary heat exchanger and coolant circulating mechanism are integral to the electric device.

43. The system of claim 34, wherein the coolant is a gas.

44. The system of claim 34, wherein the coolant is a liquid.

45. The system of claim 44, wherein the coolant is water, refrigerant, silicon oil, Fluorient™ or acetone.

46. The system of claim 44, wherein the coolant partially fills the first volume such that the coolant is able to both evaporate and maintain contact with each of the separators while that battery pack is oriented at any angle.

47. The system of claim 44, wherein the coolant fully fills the first volume.

48. The system of claim 44, wherein each shell further comprises one or more coolant retention elements configured to maintain contact between the coolant and each of the separators while the battery pack is on an angle.

49. The system of claim 34, wherein one or more of the batteries are lithium ion battery cells.

50. The system of claim 34, wherein the separators are shaped such that outer surface of the battery cells within the separators is in physical contact with the separators.

51. The system of claim 34, wherein the battery cells within the separators are in thermal contact with the separators via a thermal medium such that the battery cells are able to easily transfer heat to the separators.

52. The system of claim 51, wherein the thermal medium is thermal grease, thermal epoxy or a thermal pad.

53. The system of claim 34, wherein each heat exchanger is composed of one or more of aluminum, copper, stainless steel or thermoplastic.

54. The system of claim 34, further comprising a filling port coupled to the shell for filling the first volume with the coolant.

55. The system of claim 34, wherein the device is an electric vehicle.

56. A method of operating a battery pack comprising:
a. positioning a plurality of battery cells within a plurality of separators extending within shells of heat exchangers of one or more battery modules, wherein a first volume is formed within the shell and outside of the separators and a second volume is formed within the separators; and
b. circulating the coolant throughout the first volume of the battery modules via one or more coolant manifolds coupling the battery modules together, wherein coolant circulating throughout the first volume contacts with the plurality of separators for dissipating localized heat produced by the battery cells throughout the heat exchanger.

57. The method of claim 56, further comprising flowing the coolant to a secondary heat exchanger via the one or more coolant manifolds in order to dissipate heat received by the coolant from the battery cells.

58. The method of claim 58, wherein the secondary heat exchanger is integral to the battery pack.

59. The method of claim 58, wherein the secondary heat exchanger is integral to an electric vehicle.

60. The method of claim 59, further comprising docking the battery pack with a docking station of the electric vehicle such that the one or more coolant manifolds are coupled with the secondary heat exchanger.
